(19) United States
(12) Patent Application Publication
(10) Pub. No.: US 2022/0300978 A1
(43) Pub. Date: Sep. 22, 2022

(54) APPARATUS AND METHODS FOR ADMINISTERING ONLINE SHOPPING BY A CHILD

(71) Applicant: Camp NYC, Inc., New York, NY (US)

(72) Inventors: Benjamin Kaufman, New York, NY (US); Melany Lynch, Apex, NC (US); Graham Blache, New York, NY (US)

(73) Assignee: Camp NYC, Inc., New York, NY (US)

(21) Appl. No.: 17/696,426

(22) Filed: Mar. 16, 2022

Related U.S. Application Data
(60) Provisional application No. 63/162,120, filed on Mar. 17, 2021.

(51) Int. Cl. G06Q 20/40; G06Q 30/06

(52) U.S. Cl. CPC G06Q 20/4037; G06Q 30/0609; G06Q 20/4014; G06Q 20/4015

(57) ABSTRACT

The present disclosure relates to apparatus and methods that allow a Parent or other designated guardian to provide an educational shopping experience to a Child within parameters that protect the Child and Parent. The Parent may indicate a price and details related to the Child's experience, including an event, an amount spent, and an teaching environment engages. Implementations may include a downloadable or pre-installed app, an API or other executable code.

### CROSS REFERENCE TO RELATED APPLICATIONS

This application claims the benefit of U.S. Provisional Patent Application No. 63/162,120, entitled Apparatus and Methods for Administering Online Shopping by a Child, filed Mar. 17, 2021, the contents of which are incorporated by reference herein.

### FIELD OF THE DISCLOSURE

The present disclosure relates to apparatus and methods and that allow a Parent or other designated guardian to educate a Child with real world experiences while controlling parameters of the Child's experience. More specifically, the present invention provides the Child with a framework including a predetermined amount of a resource (e.g., money, time) to be spent during a shopping experience by the Child, an event related to the shopping experience, and guides to mentor the Child during the shopping experience.

### BACKGROUND OF THE DISCLOSURE

Traditionally, Children (less than 13 years old) or legal minors (less than 18 years old) access distributed networks, such as the Internet, to shop or engage in other ecommerce, such as ordering online media and the like has been available in an unmitigated fashion. Once a Parent provides authorization for a Child to have access to a site, or to engage in an online ecommerce transaction, the Parent does not have a method or apparatus to effectively monitor or control what the Child is exposed to, or to what the Child purchases.

Online interactions may provide benefits for a Child, such as useful shopping skills, but the online world may also expose the Child to unfavorable variables, such as, one or more of: overwhelming options, merchandise unsuitable for a child to be considering, and predatory sales practices that a mindful Parent wishes to protect the child from.

### SUMMARY OF THE DISCLOSURE

Accordingly, the present invention provides apparatus and methods that enable a Child to participate independently in an act of giving that involves an ecommerce transaction with the safety of parameters set by the child's Parent (or other guardian) to govern the Child's online shopping experience (sometimes referred to herein as a “Spree”). Parameter's may include, for example, one or more of: an amount of money that the Child may spend during a scheduled online transaction; an event, such as a birthday or holiday (e.g., Mother's Day) for which the Child will be engaging in an online purchase; and virtual guides. In addition, the present invention provides for fun methods of teaching a Child beneficial habits, such as how to focus on a gift recipient, and to make the gift something that the recipient will enjoy.

In some alternative embodiments, disparate network access devices may be operated by a Parent and a Child respectively to present the online shopping experience to the Child. For example, a Parent may interact with an online device (such as the Parent's smart phone) to initiate a shopping experience and designate an event for which the shopping will be related to, a gift recipient, and payment details including an amount to be spent. A Child may then be provided with a Code that the Child may enter into a same or different smart device (e.g., a Child's tablet device). Once the Code is entered, the Child may proceed with the ecommerce shopping experience within the guidelines selected by the Parent. A parent may be kept apprised of the child's progress.

In some embodiments, in addition to required parameters of a shopping experience, such as payment details and event, a Parent may select a particular shopping experience to be provided to the Child. For example, one shopping experience may be tailored to teaching a Child to share, another shopping experience may be tailored towards teaching a Child to make decisions on their own, still another shopping experience may be tailored towards presenting research and reviews related to potential products to purchase, and so on.

In another aspect, the Parent may be provided an opportunity to present the Child with a shopping experience that guides a Child to select a category of gift for another Person. By way of non-limiting example, a Child may be presented with a shopping experience that guides the Child to select one or more of: a STEM (Science Technology Engineering Mathematics) oriented gift for another Child in order to promote a beneficial learning experience to the Child receiving the gift; or a Child may be guided to choosing a gift promoting an outdoor activity for an adult gift recipient that is normally office-bound; another experience may promote music or the arts. Other variables in the Child's shopping experience may include one or more of: which characters the Child will encounter during the Child's shopping experience; a style of language used; an underlying message or theme (e.g., conservation, generosity, self-sufficiency, etc.).

In another aspect, an adult is registered as the Parent (or guardian or other responsible person, such as a teacher, relative or caregiver) of the Child and kept apprised of a status of the shopping experience engaged in by the Child. In some embodiments, a person acting as Parent is certified as an adult via an identification mechanism, such as, for example a driver's license number, credit card or a social security number. The Parent may be provided functionality to assist the Child, limit presentation of certain products of services for sale, promote certain products or services during the Child's experience, create a “short list” of product options from which the Child may choose, and the like.

A location for one or both of the Parent interaction and the Child interaction may be a same general location (e.g., a home, a store, an entertainment venue etc.) or disparate venues, such as a Parent at work and a Child at home or in day care. Additional embodiments are within the scope of this disclosure and accompanying claims.

A Parent may also provide initiation instructions that guide the Child through a preferred type of Spree experience. In some embodiments, a Parent may be apprised of a Child's progress in completing the Spree, including whether or not the Spree is completed. Updates on a status of a Spree may be important in the case where the Parent needs to ascertain whether a Gift has been given to a Recipient, such as for a birthday or other occasion.

Also, a Parent may be interested in monitoring a Child's ability to traverse actions involved in a Spree (and interest). Moreover, in some embodiments, a Parent may save steps taken by a Child and a route the Child follows during a Spree, including, by way of non-limiting example, response to animations, choices made in response to stimuli, response to music or sound effects. In addition, a Child Gift Giving system may monitor such responses and other actions and use neural networks or other machine learning tools to analyze actions undertaken by one or more of a Parent, a Child, and a Gift Recipient. In some embodiments, the child's Parent may be provided with a summary derived from machine learning

In some embodiments, a child may be mentored through an online transaction with online animation, such as an avatar, or other interactive guide (sometimes referred to as a Scout). The Scout provides tutoring to the Child during the Spree experience and apprise the Child (and Parent) of a current status, including when the Child has finished with the Spree experience.

Other aspects may include an avatar or other animation to notify a Child and/or Parent of a number of Coins (or other means of currency used in a Child Gift Giving system). Some implementations may include a practice experience to instruct a Child before bringing the Child through a “live” experience.

In still another aspect, in some embodiments, a Child may work through “Quizzes” to educate the Child on choices available and to assist the Child in Gift selection. Answers to Quiz questions (sometimes referred to herein as “Collections”) may be analyzed to assist in understanding one or more of: a thought process engaged by a Child; a message conveyed by particular animations or avatar scripts; results of interactive processes; and whether a Parent's objective in initiating the Spree has been accomplished.

In some embodiments a Child Gift Giving system may include multiple types of codes, such as, by way of non-limiting example: a code for a Sprees to one recipient, e.g. Birthday (event) codes—enter code & allow people to buy a package associated with a pre-existing shipping address; (one perpetual spree, multiple shipments, refillable code)—Allowance codes—one perpetual spree with multiple shipments (e.g. a code stays with a kid and they can trigger a shipment every time they hit X coins in their bag); one to one Spree codes.

Preferably a user will input a code in a code box presented in a user interface (UI) via a uniform resource locator (URL) and if they enter a birthday code they can buy a package in exchange for the code, if they enter an allowance code the system may query whether if the user is a Parent or Child. If the user is a Parent, the system will age gate the user to ascertain the user's age and put them on the refill page, if the user is a Child, or in the event of a failed age gate, the system may place them directly into a perpetual allowance spree. If a user enters a Spree code the System may drop them directly into their Spree.

Some embodiments may remind users to place a volume control at an appropriate level and/or ascertain if they wish to ‘top up’ a spree code; for example, if a Child runs out of points and wants more before they are done with the Spree.

Some embodiments may include a method of delivering a product to a recipient designated by a child based on parameters specified by a parent, the method including the steps of prompting a parent, on a parent smart device, to input a parent parameter. Embodiments may also include generating an authentication code on the parent smart device.

Some embodiments include transmitting the parent parameter and the authentication code from the parent smart device, via a communications device, to a first server. Embodiments may also include transmitting, via the first server, a child prompt to a child smart device based upon the parent parameter. Embodiments may also include displaying on the child smart device one or more products associated with the parent parameter based upon receipt of the authentication code.

Some embodiments include receiving a selection of one or more products from the child smart device. Embodiments may also include transmitting, via the child smart device, the selection to a second server. Embodiments may also include causing the selection to be shipped to a location designated by the parent.

In some embodiments, the parent parameter may be an event and/or a budget. Some embodiments may also include the step of prompting, on the child smart device, the selection of a card.

In some embodiments, a budget may be set in a first currency, and the budget may be transformed by a conversion function to a second currency as a converted budget, and the converted budget may be transmitted to the child. In some embodiments, the conversion function may be based upon a maximum amount set by the parent. In other embodiments, a parent parameter may include a lesson.

Embodiments may further include the step of displaying a mascot on the child smart device, wherein the mascot acts as a mentor to guide the child.

### BRIEF DESCRIPTION OF THE DRAWINGS

The accompanying drawings, that are incorporated in and constitute a part of this specification, illustrate several embodiments of the disclosure and, together with the description, serve to explain the principles of the disclosure:

FIG. 1 illustrates a functional diagram of some exemplary systems according to some embodiments of the present invention.

FIG. 2 illustrates method steps according to some embodiments of the present invention.

FIG. 3 illustrates a block diagram involving some embodiments of the present invention.

FIG. 4 illustrates aspects of controller hardware useful for implementing the present invention as a block diagram.

FIG. 5 illustrates an exemplary processing and interface system.

FIG. 6 illustrates a block diagram of an exemplary embodiment of a mobile device.

FIG. 7 illustrates an exemplary embodiment of a Parent initiation screen.

FIG. 8 illustrates an exemplary embodiment of a Parent confirmation screen including the authentication code to send to the Child.

FIG. 9 illustrates an exemplary embodiment of a Parent confirmation screen including shipping and Product information.

FIG. 10 illustrates an exemplary embodiment of a Parent screen for inputting billing information.

FIG. 11 illustrates an exemplary embodiment of a screen on the Child smart device for the Child to enter a code to shop.

FIG. 12 illustrates an exemplary embodiment of a shopfront with a Coin display.

FIG. 13 illustrates an exemplary embodiment of a shopping cart divided into tiers based on a Coin amount.

FIG. 14 illustrates an exemplary embodiment of a card selection screen based upon an Event.

FIG. 15 illustrates an exemplary embodiment of a confirmation screen.

FIG. 16 illustrates method of delivering a product to a recipient, according to some embodiments of the present invention.

### DETAILED DESCRIPTION

The present invention provides apparatus and methods that allow a Parent or other designated guardian to initiate and monitor a shopping experience of a Child. The Child is guided through a shopping experience in a fun, game like process. Ultimately, an ecommerce purchase is completed by the Child in an independent fashion, but with oversight by the Parent, including authorization and participation.

In the following sections, detailed descriptions of examples and methods of the disclosure will be given. The description of both preferred and alternative examples, though thorough, are exemplary only, and it is understood to those skilled in the art that variations, modifications, and alterations may be apparent. It is therefore to be understood that the examples do not limit the broadness of the aspects of the underlying disclosure as defined by the claims.

### Glossary

As used herein, a “Child” means a person 13 years of age or younger who is associated with a Parent.

As used herein, a “Code” means a virtual token, passphrase, or other identifier that a Child can use to enter the ecommerce shop.

As used herein, a “Coin” means shop currency, wherein shop currency includes a virtual value that may be exchanged for a Product or other Gift.

As used herein, an “Event” means any event for which a gift would be appropriate, such as a holiday, birthday, celebration, or other identifiable happening.

As used herein, a “Gift” means an item or service (e.g., a video, movie, or audio track, or admission to an entertainment facility or movie facility).

As used herein, a “Minor” means a person between the ages of 14 and 18 years old who is associated with a Parent. In the following discussion, unless specifically indicated otherwise, a Child will include a Minor.

As used herein, a “Parent” means an adult associated with at least one of: a Child and a Minor. In some embodiments, a Parent will be certified as an adult. For the sake of ease of discussion, a “Parent” will include any authorized adult, guardian, or agent with responsibility for a Child involved in a purchasing process according to the present invention.

As used herein, a “Present” means a collection of chosen products/services/output of a completed spree that may be delivered via a shipment, electronic streaming, personal service, or other appropriate delivery mechanism.

As used herein, a “Purchase” includes an ecommerce transaction that is initiated and paid for by a Parent and consummated by a Child.

As used herein, a “Recipient” means a person that will receive a Gift.

As used herein, a “Spree” means a shopping experience. A Spree may be responsive to an event, such as a birthday or holiday, or as part of a Child's routine, such as a weekly allowance or as a reward for completing tasks or achieving good grades, or other accomplishment.

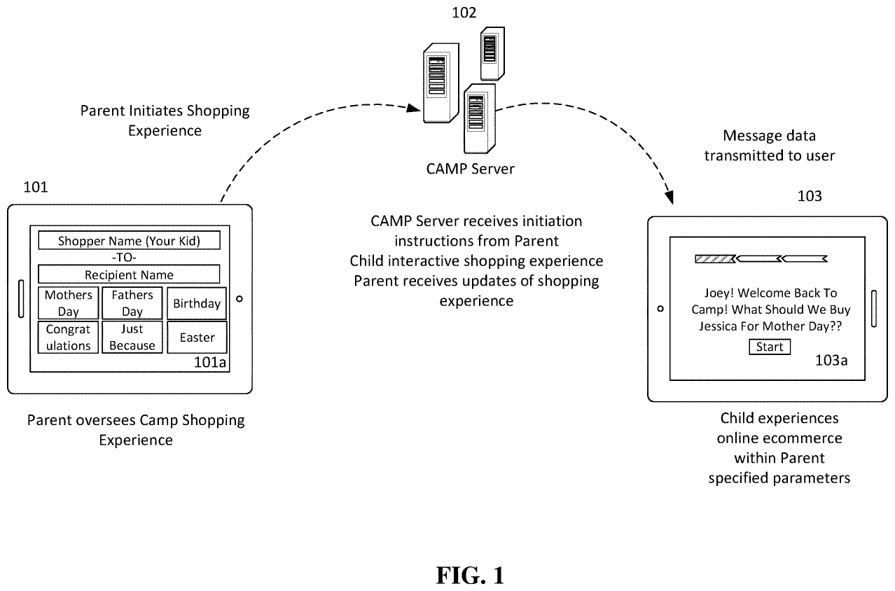

Referring now to FIG. 1, according to the present invention, a Parent initiates a shopping experience on a Parent smart device 101. The Parent may interact with a Parent smart device interactive interface 101a presented on the Parent smart device 101 to cause a Spree to take place. For example, the Parent may indicate via the Parent Interactive Interface to indicate one or more of: a price to spend on the Spree; a Gift recipient; an Event or occasion relevant to the shopping experience; a theme for the Spree; a Parent-preferred genre of Gift for the Child to select; a preferred lesson for the Child to experience; or a preferred Recipient for the Gift (or in some embodiments a designated Recipient) of the Gift.

A CAMP server 102 may receive digital input quantifying selections made by the Parent on the Parent Smart Device 101 via a communications device associated with Parent Smart Device 101 and generate a purchase sequence. The purchase sequence may include receipt of Purchase parameters resulting from a first user interactive interface (a Parent Interactive Interface 101a); generation of a Child authorization Code; receipt of Purchase details from a Child Interactive Interface 103a and completion of an ecommerce transaction based upon the Purchase details received from the Child Interactive Interface.

Purchase parameters may include a time for the Purchase to take place, a pecuniary amount associated with the transaction (such as a Coin limit); a chosen Child to select the Gift, a Recipient for the Gift (or in some embodiments, a group of people from which a Child may select the Recipient), and values for variables required and/or desired to complete the Gift Purchase.

In some embodiments, one or both of the Parent Interactive Interface 101a and the Child Interactive Interface 103a may be generated on the CAMP server 102 and transmitted to the respective smart devices. In other embodiments, a smart device 101, 103 may generate the respective interactive interface 101a, 103a, and populate the respective interactive interface 101a, 103a, with data representing the values for variables involved in the CAMP purchased transaction.

Either the Parent Smart Device 101 or the CAMP server 102 may additionally generate an authorization Code that is transmitted to the Child Smart Device 103, receipt of which by the Child Smart Device 103 may cause a display on Child Smart Device 103 to display the Code or a related prompt. The Child may input the authorization Code into a Purchase Authorization screen in order to access a purchase experience initiated by a Parent. The Purchase Authorization Code may be linked to variables associated with a Purchase, such as an amount of a Purchase, a Child to make the Purchase, a Recipient of a Gift purchased; an Event involved in the Purchase, a Purchase theme to be presented to the Child during the Purchase experience, a notification of a status of a pending Purchase, a notification of a completion of a Purchase, and any other variable included in the purchase experience.

In some embodiments, the CAMP server 102 may be a separate entity from the server providing the appropriate Products (i.e., the Product Server). In these embodiments, one or more communications from the Parent Smart Device 101 or the Child Smart Device 103 may be sent to the CAMP server 102, the Product Server, or both, as described in more detail herein.

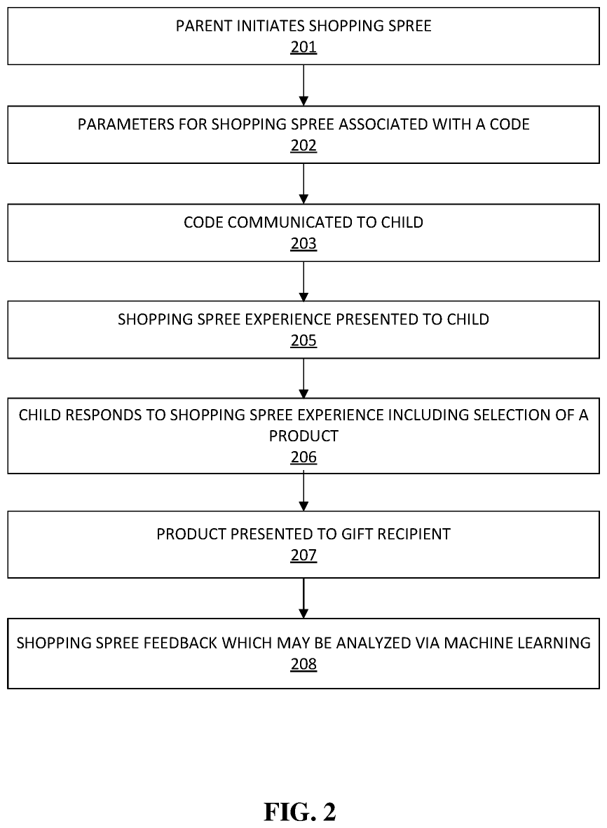

Referring now to FIG. 2, a flowchart diagram illustrates method steps that may be implemented in some embodiments of the present invention.

At step 201 a Parent initiates a shopping experience that may be referred to as a Spree. The initiation may be very basic, such as, an amount of Coin or money that a Child may spend, or may be more detailed and include one or more of: an occasion to be recognized; a lesson to be presented to the Child (e.g., gratitude, generosity, STEM, physical activity. Imagination, development of skill such as art or music, etc.), a timeframe for the Spree, consummation of the Spree, and who should receive feedback.

At step 202, an automated processor, such as a controller, associated the parameters of the Spree with an authorization code.

At step 203, the authorization code is communicated to the Child involved in the Spree. Communication of the Code may be accomplished, for example, via one or more of: a gift card that is mailed, SMS message, social media, other electronic communication or via conversation.

At step 205, the Child's Spree experience is presented to the Child and at step 206, the Child responds to the Spree experience. In some embodiments, the Parent or other party may be apprised of the Child's progress with the Spree experience.

At step 207, one or more Gifts (sometimes referred to as a Product) is presented to the Gift Recipient. In some embodiments, this may be done virtually, such as by sending an electronic message to the Gift Recipient. In other embodiments, this may be done by transmitting to a fulfillment shipper via Internet protocol a digital representation of the Gift, which may comprise one or more Products, as well as a digital description of the Product.

At step 208, Spree experience feedback is provided to an automated system providing the Spree (or other feedback receiving automated processor). The feedback may indicate a level of satisfaction of one or more of the Parent, the Child, and Gift recipient, whether a Parent's objective for the Spree was accomplished, and performance of a Vendor involved in the Spree. In some embodiments, feedback may be used as input into a machine learning process that is used to improve various aspects of the Child Giving system, or indicate unrealized results of the Child Gift Giving experience.

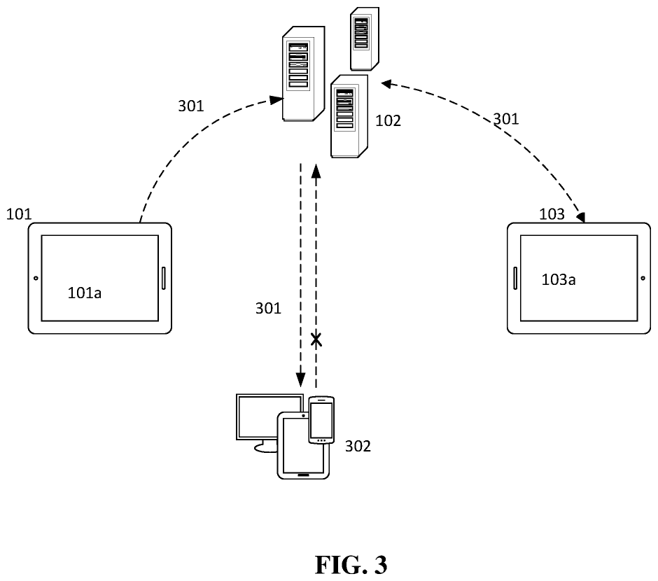

Referring now to FIG. 3, a block diagram indicates the smart devices of the Parent 101, and the Child 103 are in logical communication with Gift giving automation 102 such as an online server, also in logical communication 301 with a Gift Recipient smart device 302. Although some smart devices 101 and 103 are illustrated in a form of a tablet or smart phone, it should be understood that any device with a controller that is capable of executing software, such as a PC, tablet or smart phone is within the scope of the present invention.

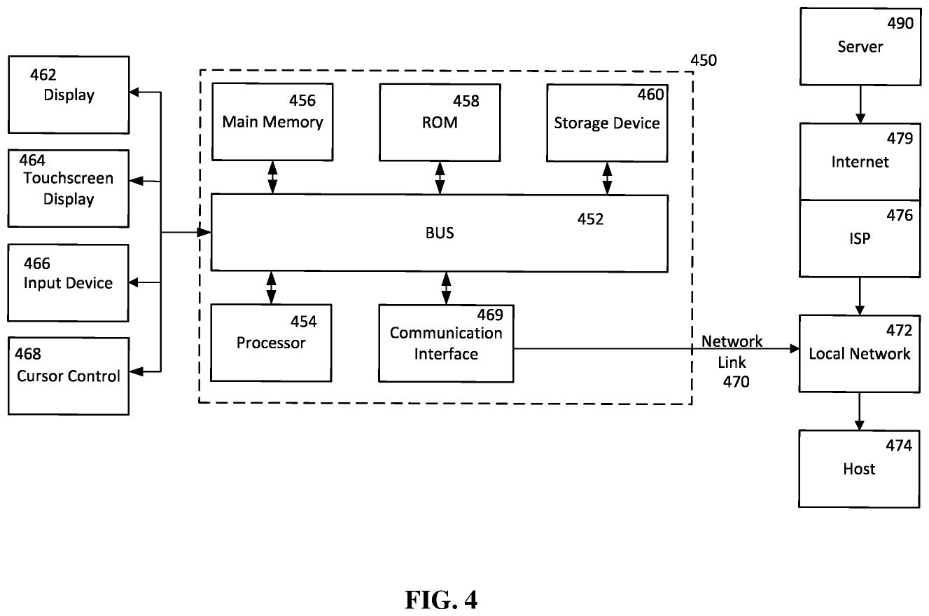

Referring now to FIG. 4, additional aspects of controller hardware useful for implementing the present invention are illustrated as a block diagram that includes a controller 450 upon which an embodiment of the invention may be implemented. Controller 450 includes a bus 452 or other communication mechanism for communicating information, a database to track message status, and a processor 454 coupled with bus 452 for processing information. In some implementations, the controller will be cloud based such as the Heroku™ cloud platform.

Controller 450 also includes a main memory 456, such as a random access memory (RAM) or other dynamic storage device, coupled to bus 452 for storing information and instructions to be executed by processor 454. Main memory 456 may also be used for storing temporary variables, data records or other intermediate information during execution of instructions to be executed by processor 454. Main memory 456 may also store a log of messages sent from a first user 201 to a second user 205 and actions, such as approvals or denials taken by Parents/guardians regarding messages sent. Controller 450 further includes a read only memory (ROM) 458 or other static storage device 460.

Controller 450 may be coupled via bus 452 to a display 462, such as a cathode ray tube (CRT), liquid crystal display (LCD), plasma display panel (PDP), organic light-emitting diode (OLED), projector, or heads up display for displaying information to a computer user. An input device 466, including alphanumeric and other keys, may be coupled to bus 452 for communicating information and command selections to processor 454. Another type of user input device is cursor control 468, such as a mouse, a trackball, a touchpad, or cursor direction keys for communicating direction information and command selections to processor 454 and for controlling cursor movement on display 462. Another type of user input device is a touchscreen display 464 where a user may communicate information and command selections to processor 454 by tactile interaction with the display thereby controlling cursor movement or alphanumeric and other keys. This input device typically has two degrees of freedom in two axes, a first axis (e.g., x) and a second axis (e.g., y), that allows the device to specify positions in a plane. Other implementations may include a 3D touch or other device to register “gestures” and “multiple touch points (i.e., two finger swipe).

Embodiments of the invention are related to the use of controller 450 for setting operational parameters relating to digital messaging and game playing. According to some embodiment of the invention, parameters may be defined and managed by controller 450 in response to processor 454 executing one or more sequences of one or more instructions contained in main memory 456. Such instructions may be read into main memory 456 from another computer-readable medium, such as storage device 460. Execution of the sequences of instructions contained in main memory 456 causes processor 454 to perform the process steps described herein. In alternative embodiments, hard-wired circuitry may be used in place of or in combination with software instructions to implement the invention. Thus, embodiments of the invention are not limited to any specific combination of hardware circuitry, input methods and software.

The term “computer-readable medium” as used herein refers to any medium that participates in providing instructions to processor 454 for execution. Such a medium may take many forms, including but not limited to, non-volatile media, volatile media, and transmission media. Non-volatile media includes, for example, optical or magnetic disks, such as storage device 460 and 458. Volatile media includes dynamic memory, such as main memory 456. Transmission media includes coaxial cables, copper wire and fiber optics, including the wires that comprise bus 452. Transmission media may also take the form of acoustic or light waves, such as those generated during radio wave and infrared data communications (i.e., WiFi and 4G LTE, Bluetooth, and other wireless digital communication protocols).

Common forms of computer-readable media include, for example, a memory stick, hard disk or any other magnetic medium, a Solid State Disk (SSD), a CD-ROM, any other optical medium, a RAM, a PROM, and EEPROM, any other memory chip or cartridge, or any other medium from which a computer may read.

Various forms of computer readable media may be involved in carrying one or more sequences of one or more instructions to processor 454 for execution. For example, the instructions may initially be carried on a magnetic or solid state disk of a remote computer. The remote computer can load the instructions into its dynamic memory and send the instructions over a distributed network such as the Internet. A communication device may receive the data on the telephone line, cable line, or fiber-optic line and use an infrared transmitter to convert the data to an infrared signal. An infrared detector can receive the data carried in the infrared signal and appropriate circuitry can place the data on bus 452. Bus 452 carries the data to main memory 456, from which processor 454 retrieves and executes the instructions. The instructions received by main memory 456 may optionally be stored on storage device 460 either before or after execution by processor 454.

Controller 450 also includes a communication interface 469 coupled to bus 452. Communication interface 469 provides a two-way data communication coupling to a network link 470 that may be connected to a local network 472. For example, communication interface 469 may operate according to the Internet protocol. As another example, communication interface 469 may be a local area network (LAN) card allowing a data communication connection to a compatible LAN. Wireless links may also be implemented.

Network link 470 typically provides data communication through one or more networks to other data devices. For example, network link 470 provides a connection through local network 472 to a host computer 474 or to data equipment operated by an Internet Service Provider (ISP) 476. ISP 476 in turn provides data communication services through the worldwide packet data communication network now commonly referred to as the “Internet” 479. Local network 472 and Internet 479 both use electrical, electromagnetic, or optical signals that carry digital data streams. The signals through the various networks and the signals on the network link 470 and through communication interface 469, which carry the digital data to and from controller 450 are exemplary forms of carrier waves transporting the information.

In some embodiments, Controller 450 may send messages and receive data, including program code, through the network(s), network link 470 and communication interface 469. In the Internet example, a server 490 might transmit a requested code for an application program through Internet 479, ISP 476, local network 472 and communication interface 469.

Processor 454 may execute the received code as it is received, and/or stored in storage device 460, or other non-volatile storage for later execution. In this manner, controller 450 may obtain application code in the form of a carrier wave.

Access devices may include any device capable of interacting with controller or other service provider. Some exemplary devices may include a mobile phone, a smart phone, a tablet, a netbook, a notebook computer, a laptop computer, a wearable computing or electronic device, a terminal, a kiosk, or other type of automated apparatus. Additional exemplary devices may include any device with a processor executing programmable commands to accomplish the steps described herein.

A controller may be a programmable board such as an Arduino board, and/or one or more of: personal computers, laptops, pad and tablet devices, mobile phone devices and workstations located locally or at remote locations, but in communication with the system. System apparatus can include digital electronic circuitry included within computer hardware, firmware, software, or in combinations thereof. Additionally, aspects of the invention can be implemented manually.

Apparatus of the invention can be implemented in a computer program product tangibly embodied in a machine-readable storage device for execution by a programmable processor and method actions can be performed by a programmable processor executing a program of instructions to perform functions of the invention by operating on input data and generating output. The present invention may be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object oriented programming language, or in assembly or machine language if desired, and in any case, the language can be a compiled or interpreted language. Suitable processors include, by way of example, both general and special purpose microprocessors.

Generally, a processor will receive instructions and data from a read-only memory and/or a random access memory. Generally, a computer will include one or more mass storage devices for storing data files; such devices include magnetic or solid state disks, such as internal hard disks and removable disks magneto-optical disks and optical disks. Storage devices suitable for tangibly embodying computer program instructions and data include all forms of non-volatile memory, including, by way of example, semiconductor memory devices, such as EEPROM and flash memory devices; magnetic disks such as, internal hard disks and removable disks; and CD ROM disks. Any of the foregoing can be supplemented by, or incorporated in, ASICs (application-specific integrated circuits).

In some embodiments, implementation of the features of the present invention is accomplished via digital computer utilizing uniquely defined controlling logic, wherein the controller includes an integrated network between and among the various participants in Process Instruments.

The specific hardware configuration used is not particularly critical, as long as the processing power is adequate in terms of memory, information updating, order execution, redemption, and issuance. Any number of commercially available database engines may allow for substantial account coverage and expansion. The controlling logic may use a language and compiler consistent with that on a CPU included in the user device. These selections will be set according to per se well-known conventions in the software and mobile device community.

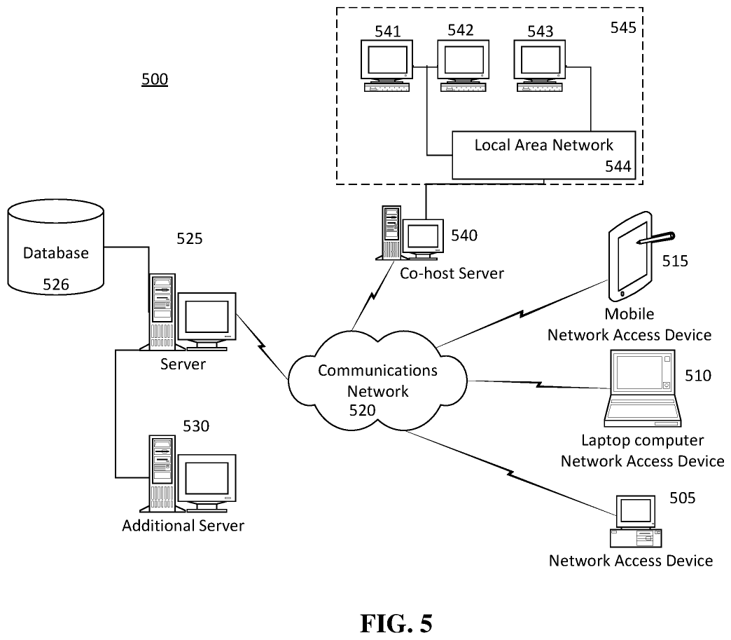

Referring now to FIG. 5, an exemplary processing and interface system 500 is illustrated. In some aspects, access devices 515, 510, 505, such as a mobile device 515 or laptop computer 510 may be able to communicate with an external server 525 though a communications network 520. The external server 525 may be in logical communication with a database 526, which may comprise data related to identification information and associated profile information. In some examples, the server 525 may be in logical communication with an additional server 530, which may comprise supplemental processing capabilities.

In some aspects, the server 525 and access devices 505, 510, 515 may be able to communicate with a cohost server 540 through a communications network 520. The cohost server 540 may be in logical communication with an internal network 545 comprising network access devices 541, 542, 543 and a local area network 544. For example, the cohost server 540 may comprise a payment service, such a social network, such as Facebook™ or a game or dating website.

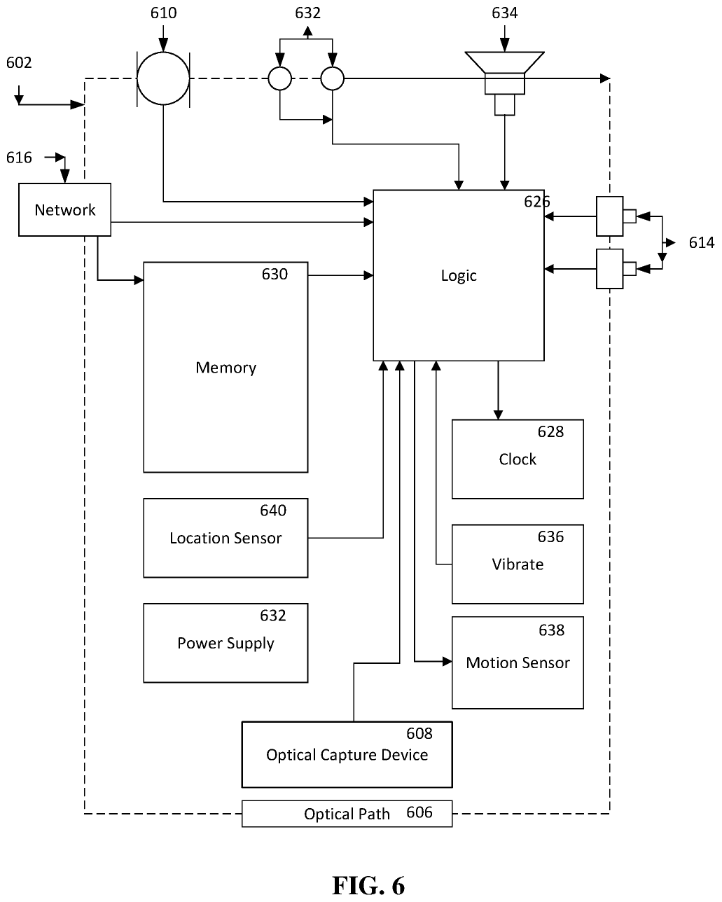

Referring now to FIG. 6, a block diagram of an exemplary embodiment of a mobile device 602 is illustrated. The mobile device 602 may comprise an optical capture device 608, the optical capture device 608 may incorporate a Charge-Coupled Device (CCD), a Complementary Metal Oxide Semiconductor (CMOS) imaging device, or an optical sensor of another type.

In some embodiments, the mobile device 602 may comprise a microphone 610, wherein the microphone 610 and associated circuitry may convert the sound of the environment, including spoken words, into machine-compatible signals. Input facilities 614 may exist in the form of buttons, scroll-wheels, or other tactile sensors such as touch-pads. In some embodiments, input facilities 614 may include a touchscreen display. Visual feedback 632 to the user may occur through a visual display, touchscreen display, or indicator lights. Audible feedback 634 may be transmitted through a loudspeaker or other audio transducer. Tactile feedback may be provided through a vibration module 636.

In some aspects, the mobile device 602 may comprise a motion sensor 638, wherein the motion sensor 638 and associated circuitry may convert the motion of the mobile device 602 into machine-compatible signals. For example, the motion sensor 638 may comprise an accelerometer, which may be used to sense measurable physical acceleration, orientation, vibration, and other movements. In some embodiments, the motion sensor 638 may comprise a gyroscope or other device to sense different motions.

In some implementations, the mobile device 602 may comprise a location sensor 640, wherein the location sensor 640 and associated circuitry may be used to determine the location of the device. The location sensor 640 may detect Global Position System (GPS) radio signals from satellites or may also use assisted GPS where the mobile device may use a cellular network to decrease the time necessary to determine location. In some embodiments, the location sensor 640 may use radio waves to determine the distance from known radio sources such as cellular towers to determine the location of the mobile device 602. In some embodiments these radio signals may be used in addition to and/or in conjunction with GPS.

In some aspects, the mobile device 602 may comprise a logic module 626, which may place the components of the mobile device 602 into electrical and logical communication. The electrical and logical communication may allow the components to interact. Accordingly, in some embodiments, the received signals from the components may be processed into different formats and/or interpretations to allow for the logical communication. The logic module 626 may be operable to read and write data and program instructions stored in associated storage 630, such as RAM, ROM, flash, or other suitable memory. In some aspects, the logic module 626 may read a time signal from the clock unit 628. In some embodiments, the mobile device 602 may comprise an on-board power supply 632. In some embodiments, the mobile device 602 may be powered from a tethered connection to another device, such as a Universal Serial Bus (USB) connection.

In some implementations, the mobile device 602 may comprise a network interface 616, which may allow the mobile device 602 to communicate and/or receive data to a network and/or an associated computing device. The network interface 616 may provide two-way data communication. For example, the network interface 616 may operate according to an internet protocol. As another example, the network interface 616 may comprise a local area network (LAN) card, which may allow a data communication connection to a compatible LAN. As another example, the network interface 616 may comprise a cellular antenna and associated circuitry, which may allow the mobile device to communicate over standard wireless data communication networks. In some implementations, the network interface 616 may comprise a Universal Serial Bus (USB) to supply power or transmit data. In some embodiments, other wireless links known to those skilled in the art may also be implemented.

As an illustrative example of a mobile device 602, a reader may scan some text from a newspaper article with mobile device 602. The text is scanned as a bit-mapped image via the optical capture device 608. Logic 626 causes the bit-mapped image to be stored in memory 630 with an associated time-stamp read from the clock unit 628. Logic 626 may also perform optical character recognition (OCR) or other post-scan processing on the bit-mapped image to convert it to text. Logic 626 may optionally extract a signature from the image, for example by performing a convolution-like process to locate repeating occurrences of characters, symbols, or objects, and determine the distance or number of other characters, symbols, or objects between these repeated elements. The reader may then upload the bit-mapped image (or text or other signature if post-scan processing has been performed by logic 626) to an associated computer via network interface 616.

As an example of another use of mobile device 602, a reader may capture some text from an article as an audio file by using microphone 610 as an acoustic capture port. Logic 626 causes audio file to be stored in memory 628. Logic 626 may also perform voice recognition or other post-scan processing on the audio file to convert it to text. As above, the reader may then upload the audio file (or text produced by post-scan processing performed by logic 626) to an associated computer via network interface 616.

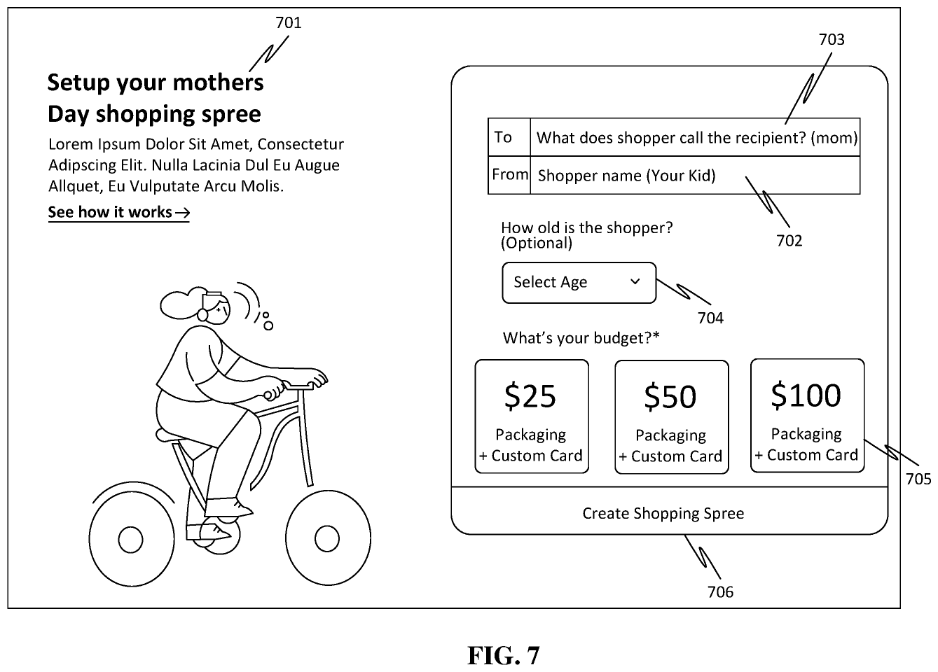

FIGS. 7-15 illustrate aspects that may be included in various embodiments of the present invention. In some embodiments, the following screens may be accessed in a virtual world, or alternative universe, such as for example, a the Metaverse™ or similar environment or an augmented reality environment that combines a real world physical brick and mortar structure and virtual guidance and parameters, such as those described herein. For example, one participant (such as the Parent) can monitor the activities of another participant (such as the Child).

Referring now to FIG. 7, an exemplary Parent screen display is shown. Parent screen display may include an Event designation 701, Child designation 702, Recipient designation 703, Child parameters 704, budget display 705, and confirmation option 706. Event designation 701 may display a reminder of a particular event correlated with the Spree. As shown in FIG. 7, Event designation 701 may refer to Mother's Day, but it may also refer to any Event, such as a holiday, celebration of an achievement, a birthday, or any other event for which a Gift may be appropriate.

Child designation 702 may include a space for the Parent to indicate the Child associated with the particular Spree. This Child may be the same Child as the one receiving the invitation to the Spree. Child designation 702 may include pertinent identifying information about the Child and/or their smart device, such as the Child's name, IP address, email address, phone number, device name, etc.

Recipient designation 703, similarly, may include pertinent information about a Recipient of the Gift. This may include the Recipient's name, IP address, email address, phone number, device name, relationship to the Parent or the Child, etc.

Child parameters 704 may include information that is pertinent to the types of Products to show the Child. For example, Child parameters 704 may include the Child's age (so that the shown Products are age-appropriate), interests, etc. This may also be relevant for compliance with applicable laws; for example, if the Child is not a Minor (i.e., is under the age of 13), then the U.S. Child Online Privacy Protection Act may regulate the types of data collection available to the provider of the Products or other services.

Budget display 705 may include a designation of an amount of Coin or other currency that is a maximum amount the Child may spend during the Spree. In exemplary embodiments, this may be transmitted to the Product Server to act as a filter for the Products transmitted to the Child's smart device. In some embodiments, upon the designation of a budget from the chosen options, the Parent smart device may prompt the Parent to enter payment information, such as credit card information. This may cause the Parent smart device to transmit said information to the appropriate processor for confirmation.

Confirmation option 706 may include user interactive device, such as a designated portion of a smart device touch screen that connotes a pressable button (or, in embodiments involving a smart device having a touchscreen, an area of the screen to touch) to send the Child Designation 702, Recipient designation 703, Child parameters 704, chosen budget, and any other options to the Product Server and/or to the CAMP Server.

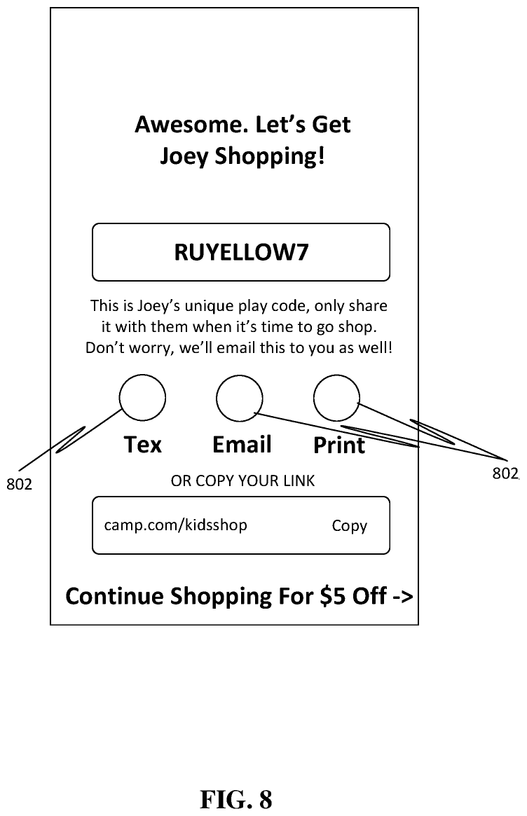

Referring now to FIG. 8, an exemplary Parent confirmation screen is shown. As discussed above, in some embodiments of the present disclosure, following transmission by the Parent Smart Device of a budget and permission by the Parent for the Child to begin the Spree, the CAMP Server may transmit to the Parent Smart Device Code 801. The transmission to the CAMP Server may instantiate a new data structure on the CAMP Server including Code 801, the associated budget and permission, and any other information to be associated with the particular Spree, such as a time limit. Code 801 may then be displayed on the Parent Smart Device.

In some embodiments, the Parent confirmation screen may also include transmission methods 802 for conveying the code from the Parent Smart Device to the Child. For example, as shown in FIG. 8, transmission methods 802 may include one or more of sending a text message to a device associated with the Child containing the Code, emailing the Code to an email address associated with the Child (which may be inputted by the Parent), sending the Code to a printer (which may be connected to the Parent Smart Device or which may be accessed wirelessly), or otherwise copying a link to the Code for sending to the Child.

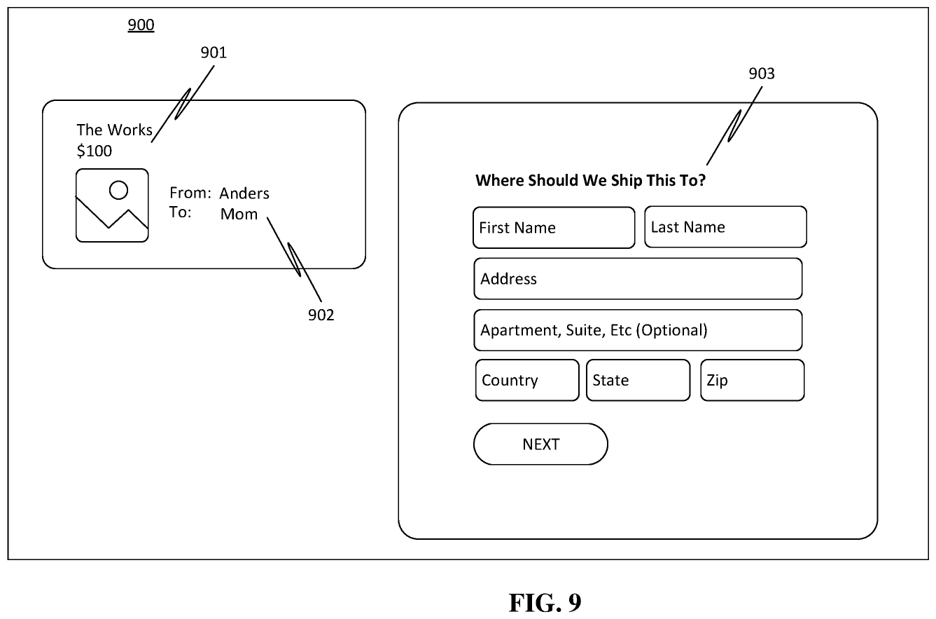

Referring now to FIG. 9, an exemplary view of an order confirmation screen is shown. Order confirmation screen 900 may include Product information 901, Gift tag information 902, and shipping information 903. Product information 901 may include pertinent information about the Product(s) included in the Gift, such as a name, a price, a picture, and a description. Gift tag information 902 may include information relating to the act of giving the Gift, such as a name of the Child, a name of the Recipient, a message, and any other information to be associated with the Gift. Shipping information 903 may include information pertinent to shipping the Gift to a physical or electronic address associated with the Recipient.

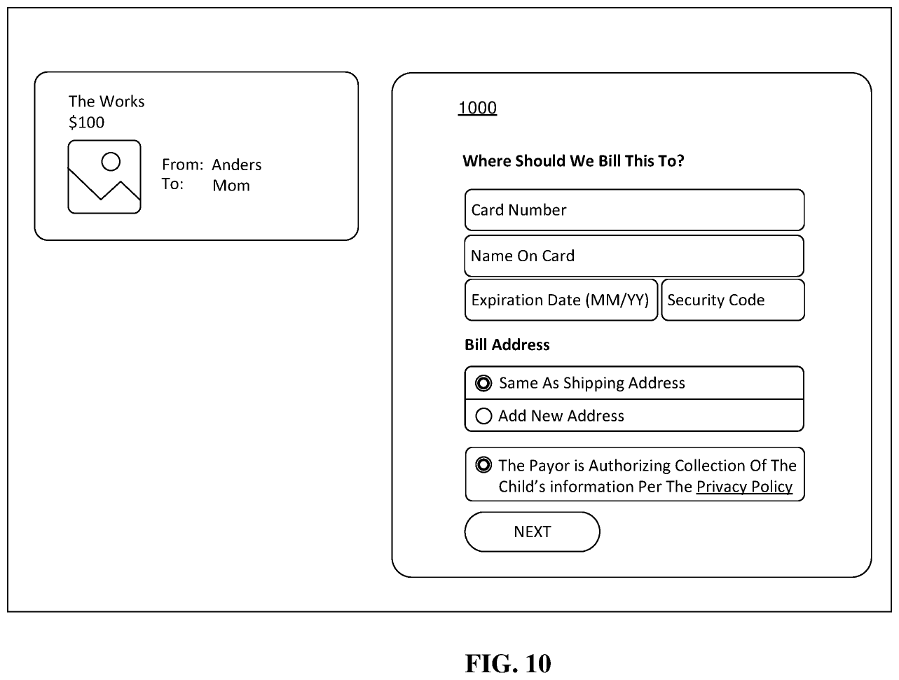

Likewise, referring now to FIG. 10, a separate screen 1000 may be used to collect billing information, including a separate authorization for collection of the Child's personally identifiable information, as permitted under applicable law or an applicable privacy policy. In another aspect, a Parent (which may also be referred to as a “Payor”) may be challenged to prove their age and ability to legally speak for the Child. The Parent may be required to complete an overt action 1001, such as activating a user interactive device on a user interface to specifically grant authorization for an automated process executed by a server or other controller to collect personally identifiable information descriptive of the Child.

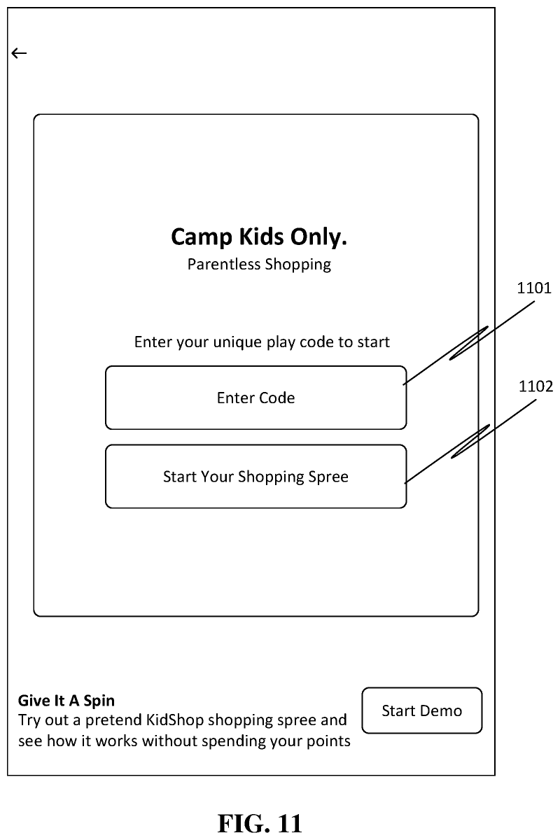

Referring now to FIG. 11, a prompt 1101 on the Child Smart Device may request that the Child enter the Code. Upon pressing button 1102, the Child Smart Device may transmit the Code to the CAMP Server. The CAMP Server may then confirm the presence of the Code in its database and transmit the associated budget to the Child Smart Device. If the Code is not located in the database, then the Child Smart Device may display an error message and invite the Child to re-enter the Code.

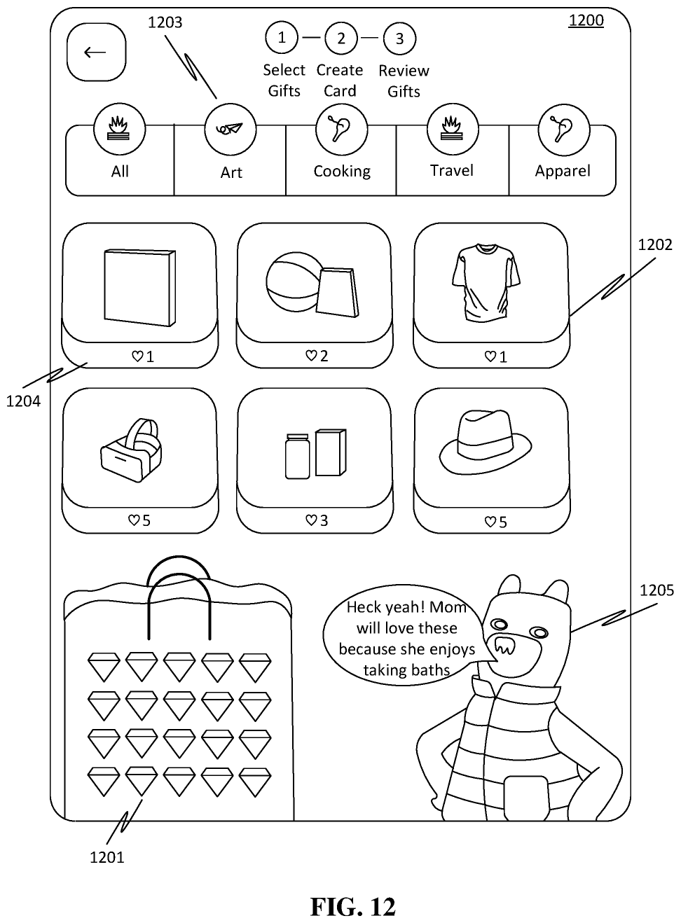

Referring now to FIG. 12, an exemplary view of a shop display 1200 as shown on the Child Smart Device is shown. Shop display 1200 may include Coin indicator 1201. Coin indicator 1201 may indicate the number of Coins still available to the Child for purchasing Products. This number of Coins may be predetermined based upon a number of Coins (or other currency) inputted by the Parent earlier in the process, such as through the method indicated in FIG. 7. As shown, Coin indicator 1201 may indicate both a number of Coins remaining and a total number of Coins available to the Child.

The Coins may be correlated with displayed Products 1202. Products 1202 may be chosen and displayed based upon one or more selection criteria, such as an age range of the Child or Recipient, a chosen interest of the Child or Recipient, a chosen lesson for the Child, and the identity of the particular Event (such as Mother's Day). The Products 1202 may be filtered using filters 1203; for example, if the Child selects the “Cooking” filter, then only Products correlated with cooking may be shown. This correlation may be achieved through prior entry in a Product database; for example, each data structure associated with the Product may include a Product name, a Product image, a price (in Coins and/or fiat currency) associated with the Product, and one or more responsive filters or categorizations, such as cooking.

Each Product 1202 may have a price 1204 correlated therewith. In exemplary embodiments, price 1204 may be displayed in Coin units, as shown. The number of Coins associated with each Product may be predetermined and associated with the Product in a data structure, as described above, or it may be determined by a conversion function, c(x). The conversion function may take relevant inputs based on real, fiat currency. For example, c(x) may depend upon the cost to a service provider of the associated Product, a desired profit margin, a cost range, a location of the Child or the Recipient (to account for cost-of-living differences), and the total budget for the Spree. In some embodiments, appropriate discounts for the Child may be based on the desired lesson and/or achievements (for example, it may be desirable to give the Child a 1 Coin discount for good grades or for altruism in choosing the Gift).

The output of c(x) may be a positive real number, which can then be correlated with an integer number of Coins. As a simple, non-limiting example, suppose the Products available for a given Spree range in real cost from $0 to $100 USD. If it is desirable for the Coin range for these Products to be between 1 and 10, then c(x)=ceil(x/10), where x is the cost of the given Product, and the function ceil(x) represents x rounded up to the next whole number. In such an embodiment, it may also be appropriate for the budget chosen by the Parent to be represented by a similar conversion function, c′(x); for example, c′(x)=floor(x/10), where x is the budget in real currency, and floor(x) represents x rounded down to the previous whole number. For example, if the designated budget is $50, then c′(x)=5 Coins available for the Spree.

In some embodiments, shop display 1200 may include mascot 1205 to provide direction to the Child. Mascot 1205 may be an animal or other avatar. The provided direction may include encouragement of the Child, which may be influenced by an input, such as the inputted Event. For example, if the Event is Mother's Day, then the mascot 1205 may provide feedback to the Child based on known or hypothesized facts about the Child's mother, such as encouraging the Child to choose bath products if it is known or hypothesized that the mother enjoys baths.

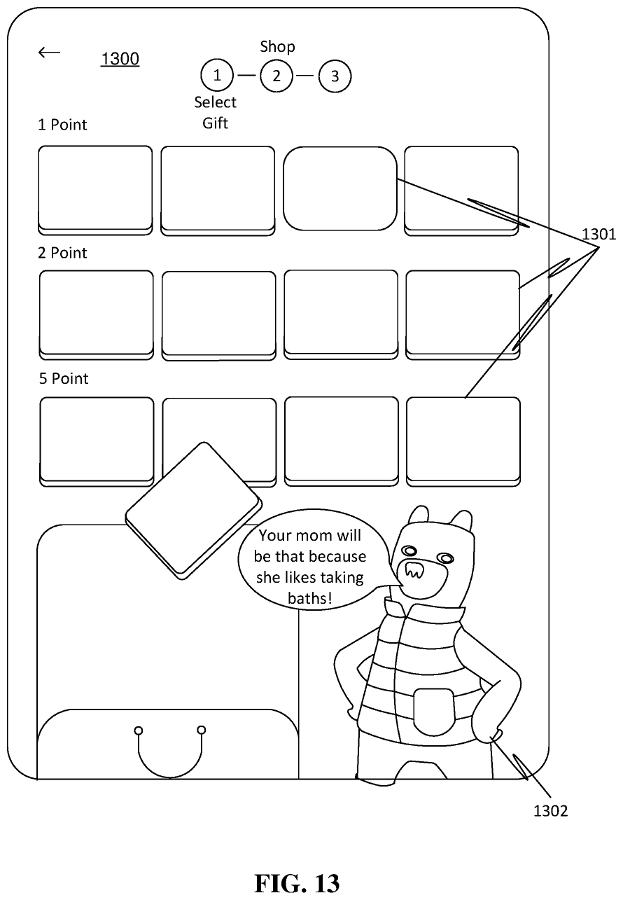

Referring now to FIG. 13, an exemplary embodiment of a shopping cart 1300 is shown. To simplify the view for the Child, shopping cart 1300 may be divided into tiers 1301 based upon the total number of Coins required for each chosen Product. As shown, there are spots available for chosen Products costing 1 Coin, 2 Coins, and 5 Coins. In some embodiments, a prompt may be shown to allow the Child to compute the total number of Coins used as a mathematical exercise, the successful solving of which may lead to a discount. In some embodiments, this screen may also include a mascot 1302, as shown in FIG. 12 as well.

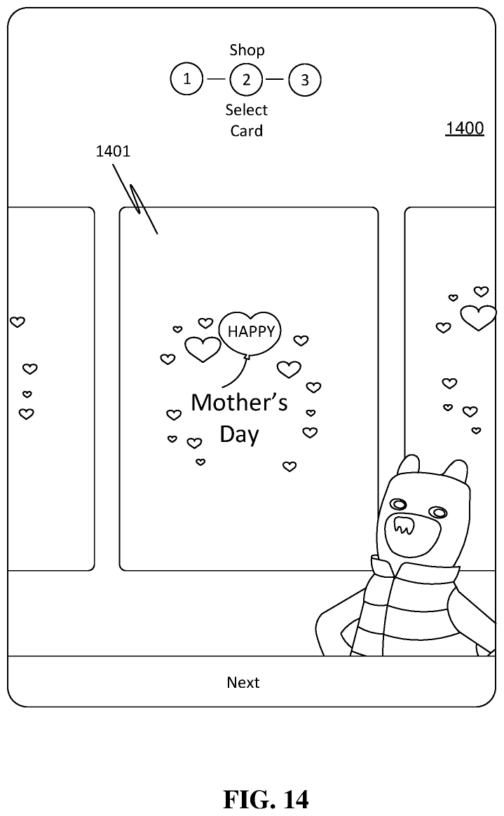

Referring now to FIG. 14, an exemplary embodiment of card selection screen 1400 is shown. In some embodiments of the present disclosure, it may be desirable to allow the Child to choose design a card and input text, narrative, stickers and freehand drawings into the card, or select a card 1401 associated with the Event. For example, as shown, the Child may choose a front of a card associated with Mother's Day. The chosen Card may be associated with the Product order or may be sent separately following the conclusion of the Spree.

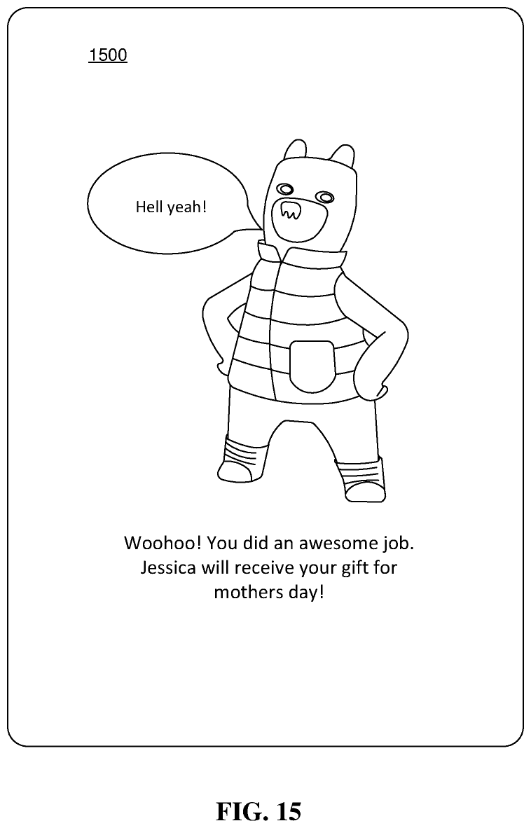

Referring now to FIG. 15, an exemplary embodiment of confirmation screen 1500 is shown. Confirmation screen 1500 may take as an input the name of the Recipient and the Event (which may be obtained through the Parent confirmation screen, shown in FIG. 8, or through other means). Upon reaching this screen, an order comprising the chosen Product information, the Recipient name and shipping address, the card (if applicable), and other pertinent information may be transmitted from one or more of (a) the Child Smart Device to the CAMP Server; (b) the Child Smart Device to a fulfillment server; or (c) the CAMP Server to a fulfillment server.

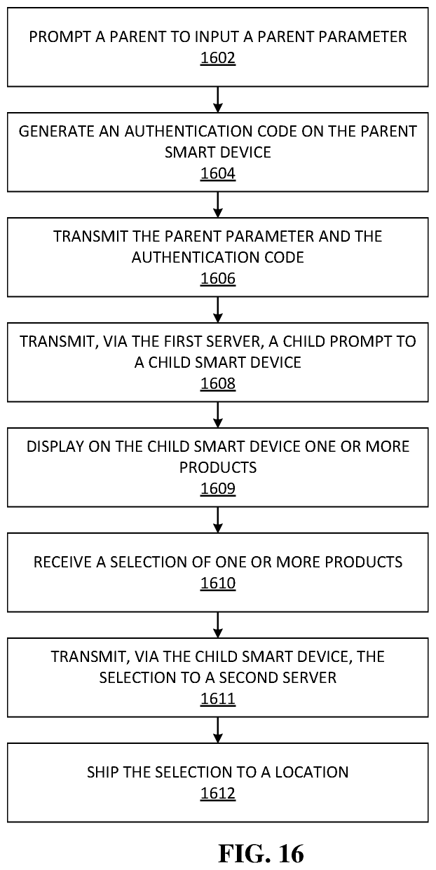

Referring now to FIG. 16 a flowchart illustrates a method of delivering a product to a recipient, according to some embodiments of the present disclosure. At step 1601, the method may include prompting a parent, on a parent smart device, to input a parent parameter. At step 1604, the method may include generating an authentication code on the parent smart device. At step 1606, the method may include transmitting the parent parameter and the authentication code from the parent smart device, via a communications device, to a first server. At step 1608, the method may further include transmitting, via the first server, a child prompt to a child smart device based upon the parent parameter.

At step 1109, the method may include displaying on the child smart device one or more products associated with the parent parameter based upon receipt of the authentication code. At step 1610, the method may include receiving a selection of one or more products from the child smart device. At step 1611, the method may include transmitting, via the child smart device, the selection to a second server. At step 1612, the method may include causing the selection to be shipped to a location designated by the parent.

### CONCLUSION

A number of embodiments of the present disclosure have been described. While this specification contains many specific implementation details, there should not be construed as limitations on the scope of any disclosures or of what may be claimed, but rather as descriptions of features specific to particular embodiments of the present disclosure.

Certain features that are described in this specification in the context of separate embodiments can also be implemented in combination in a single embodiment. Conversely, various features that are described in the context of a single embodiment can also be implemented in combination in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous.

Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order show, or sequential order, to achieve desirable results. In certain implementations, multitasking and parallel processing may be advantageous. Nevertheless, it will be understood that various modifications may be made without departing from the spirit and scope of the claimed disclosure.

What is claimed is:

1. A method of delivering a product to a recipient designated by a child based on parameters specified by a parent, the method comprising the steps of:
a. prompting a parent, on a parent smart device, to input a parent parameter;
b. generating an authentication code on the parent smart device;
c. transmitting the parent parameter and the authentication code from the parent smart device, via a communications device, to a first server;
d. transmitting, via the first server, a child prompt to a child smart device based upon the parent parameter;
e. displaying on the child smart device one or more products associated with the parent parameter based upon receipt of the authentication code;
f. receiving a selection of one or more products from the child smart device;
g. transmitting, via the child smart device, the selection to a second server; and
h. causing the selection to be shipped to a location designated by the parent.

2. The method of claim 1, wherein the parent parameter is an event.

3. The method of claim 2, further comprising the step of prompting, on the child smart device, the selection of a card.

4. The method of claim 1, wherein the parent parameter is a budget.

5. The method of claim 4, wherein the budget is set in a first currency, the budget is transformed by a conversion function to a second currency as a converted budget, and the converted budget is transmitted to the child.

6. The method of claim 5, wherein the conversion function is based upon a maximum amount set by the parent.

7. The method of claim 1, wherein the parent parameter is a lesson.

8. The method of claim 1, further comprising the step of displaying a mascot on the child smart device.

9. The method of claim 1, wherein the child smart device is an augmented reality device.

10. The method of claim 1, further comprising the step of displaying a view appearing on the child smart device on an augmented reality device associated with the parent.

11. An apparatus for delivering a product to a recipient designated by a child based on parameters specified by a parent, the apparatus comprising:
a. a processor
b. a communications device in logical communication with a communications network; and
c. a memory comprising machine-readable instructions to cause the processor to:
i. transmit a prompt to a parent, on a parent smart device, to input a parent parameter;
ii. generate an authentication code on the parent smart device;
iii. transmit the parent parameter and the authentication code from the parent smart device to the apparatus;
iv. transmit a child prompt to a child smart device based upon the parent parameter;
v. transmit instructions to display on the child smart device one or more products associated with the parent parameter based upon receipt of the authentication code;
vi. receive a selection of one or more products from the child smart device;
vii. transmit the selection to a fulfillment server; and
viii. transmit instructions to the fulfillment server to ship the selection to a location designated by the parent.

12. The apparatus of claim 11, wherein the parent parameter is an event.

13. The apparatus of claim 12, wherein the instructions further prompt the creation of a card on the child smart device.

14. The apparatus of claim 11, wherein the parent parameter is a budget.

15. The apparatus of claim 14, wherein the budget is set in a first currency, the budget is transformed by a conversion function to a second currency as a converted budget, and the converted budget is transmitted to the child.

16. The apparatus of claim 15, wherein the conversion function is based upon a maximum amount set by the parent.

17. The apparatus of claim 11, wherein the parent parameter is a lesson.

18. The apparatus of claim 11, wherein the instructions further cause the child smart device to display a mascot.

19. The apparatus of claim 11, wherein the child smart device is an augmented reality device.

20. The apparatus of claim 11, wherein the instructions further cause a view that appears on the child smart device to be transmitted to an augmented reality device associated with the parent.
